(19) United States
(12) Patent Application Publication
(10) Pub. No.: US 2010/0197838 A1
(43) Pub. Date: Aug. 5, 2010

(54) NANOPARTICLE-CONTAINING MACROCYCLIC OLIGOESTERS

(75) Inventors: Karl Koehler, Diekholzen (DE); Ferdinand Hardinghaus, Bad Honnef (DE); Jai-Won Park, Goettingen (DE); David-Christopher Glende, Goettingen (DE); Klaus Nietzel, Wennigsen (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: SOLVAY INFRA BAD HOENNINGEN, Hannover (DE)

(21) Appl. No.: 11/916,394

(22) PCT Filed: Jun. 2, 2006
(86) PCT No.: PCT/EP06/62854

§ 371 Date: Dec. 3, 2007

(30) Foreign Application Priority Data
Jun. 4, 2005 (DE) 10 2005 025 720.8

(51) Int. Cl. C08K 3/30; C08L 67/02; C08K 5/49; C08K 5/09; C08K 5/17

(52) U.S. Cl. 524/115; 524/604; 524/423; 524/320; 524/186

(57) ABSTRACT

The invention discloses polymeric esters of terephthalic acid with deagglomerated barium sulphate having an average primary particle size of less than 0.5 μm, containing a crystallization inhibitor and being coated with a dispersant, as filler. The dispersant has preferably reactive groups which are able to interact with the surface of the barium sulphate; particular preference is given to dispersants which are able to endow the barium sulphate with a hydrophilic surface and have reactive groups for coupling to or into polymers. Also disclosed is a corresponding precursor based on macrocyclic oligoesters which comprise such barium sulphate.

The present invention relates to macrocyclic oligoesters containing nanoscale particles, especially deagglomerated barium sulphate, to a precursor comprising nanoscale particles, especially deagglomerated barium sulphate, and to polyesters comprising nanoscale particles, especially deagglomerated barium sulphate, that can be prepared from the oligoesters.

U.S. Pat. No. 6,855,798 discloses macrocyclic oligoesters which can be prepared from hydroxyalkyl-terminated polyester oligomers and can be converted into linear polyesters having high crystallinity and solvent resistance.

It is an object of the present invention to specify corresponding esters (macrocyclic oligoesters, their precursor, the hydroxyl-terminated polyesters, and the end product, linear polyesters) which comprise nanoparticles and have improved properties. A preferred object is to specify esters of this kind containing nanoscale barium sulphate.

These objects are achieved by the present invention.

The invention first provides macrocyclic oligoesters preparable by reacting a dicarboxylic acid or a dicarboxylic ester with a diol to form a composition which comprises a polyester oligomer and heating the composition in the presence of a solvent and a catalyst to give the macrocyclic polyester, the macrocyclic oligoester comprising nanoscale particles (nanoparticles) of inorganic fillers.

The invention further provides hydroxyalkyl-terminated polyester oligomers which comprise nanoscale particles of inorganic fillers.

The invention additionally provides linear polyesters obtained from the macrocyclic oligoesters and comprising nanoscale fillers.

Described in the text below is the preparation of the hydroxyalkyl-terminated linear polyesters, of the macrocyclic oligoesters and of the end products, the linear polyesters with high crystallinity and solvent resistance, which comprise the nanoscale filler. Details as to how these esters (albeit without nanoscale fillers) can be prepared are found in U.S. Pat. No. 6,855,798, the disclosure content of which is hereby incorporated by reference.

The patent describes a path to the preparation of the macrocyclic polyesters by the reaction of diols with dicarboxylic acids or dicarboxylic esters in the presence of catalysts, to form a polyester oligomer containing terminal hydroxyalkyl groups. This polyester oligomer is heated, thus forming a polyester having an average molecular weight preferably in the range from 20 000 to 70 000 daltons. This medium molecular weight polyester is admixed with a solvent and heated, whereupon the desired macrocyclic esters are formed. Macrocyclic esters of this kind can be converted into the end products, polyesters such as polybutylene terephthalate or polyethylene terephthalate.

In a first step, then, hydroxyalkyl-terminated polyester oligomers are prepared. Diols used in the process are alkylene diols, cycloalkylene diols, mono- or polyoxyalkylene diols, preferably with mono- or polyoxyalkylene groups having 2 to 8 carbon atoms. Preference is given to the ethylene group and to the tetramethylene group. It is of course also possible to use mixtures of diols, and also ether diols such as diethylene glycol. The nanoscale filler to be incorporated into the hydroxyalkyl-terminated polyester oligomers can be dispersed in the diol. This achieves homogeneous distribution in the polyester oligomer.

Dicarboxylic acids or dicarboxylic esters used are compounds having a divalent aromatic or alicyclic group between the carboxyl groups. The alicyclic group may be, for example, a meta-linked or para-linked monocyclic radical. A preferred aromatic group is a para-linked C₆H₄ radical. Where dicarboxylic esters are employed as a starting material, they are preferably alkyl esters, in particular with C1-C6 alkyl groups. The preferred polyesters, accordingly, are polyethylene terephthalate (PET), polybutylene terephthalate (PBT), the corresponding isophthalates, and mixtures such as PET/PBT.

The hydroxyl-terminated linear polyesters are prepared by reacting the diol or diols and the dicarboxylic acid and/or dicarboxylic ester in a molar ratio of 1.05:1 to 1.5:1 (diol excess). In this reaction it is appropriate for a catalyst to be present, in an amount for example of 0.1 to 5 mol %, based on the diol. The temperature selected is high enough for the alcohol formed to be distilled off. When using dimethyl terephthalate, for example, heating takes place to a temperature of 140 to 200° C.

Catalysts used in the first stage, during the formation of the hydroxyalkyl-terminated compounds, are transesterification catalysts such as organotin compounds or organotitanate compounds. These are, for example, monoalkyltin(IV) hydroxyoxides, monoalkyltin(IV) dihydroxychloride and alkyltin(IV) alkoxides. Titanate catalysts such as tetraalkyl titanates, e.g. tetrakis(2-ethylhexyl) titanate, titanate esters or titanate alkoxides are likewise suitable for use.

The hydroxyalkyl-terminated polyester oligomers preparable as described above, which where appropriate already contain the fillers or a portion thereof, are then heated to form polyesters of medium molecular weight, under reduced pressure if desired, with the addition of solvents or of further catalyst. Diol liberated in this process is removed. A pressure of 5 to 625 torr and temperatures in the range from 180 to 275° C. are typical.

In the course of this process a solvent is added in order to facilitate the removal of diol by means, for example, of azeotropic distillation. As the solvent, which appropriately has a boiling point higher than that of the diol—for example, higher than 1,4-butanediol in the case of PBT preparation—it is possible to use halogenated aromatic compounds such as o-dichlorobenzene. Further catalyst can be added at this stage. This stage can also be divided into two sub-stages, with a lower temperature and a lower vacuum being employed in the first stage than in the second stage. Where a nanoscale filler has not already been introduced during the preparation of the hydroxyalkyl-terminated polyester oligomers, it can be introduced at this point, advantageously again in the form of a dispersion of the nanoscale filler in the solvent.

The process can be continued until a degree of polymerization of 95% to 98% has been reached. The molecular weight is advantageously 20 000 to 70 000 daltons. The polyester then contains even lower fractions of hydroxyalkyl-terminated oligomers.

In a further step the polymer of medium molecular weight is then heated further with the addition of a solvent, to 150 to 200° C. for example, in order to form the macrocyclic oligoesters. The purpose of the solvent is to lower the viscosity of the mixture, to facilitate the distillative removal of diol and to promote the cyclization reaction. A useful solvent in the case of PBT is 1,4-butanediol. Another solvent that can be used is o-dichlorobenzene. The solvent can also be added in two stages, in which its purpose in the first stage is to remove diol and its purpose in the second stage is to promote the cyclization, by dilution. Once again, it is possible at this stage to add nanoscale filler, if this has not already taken place in one of the preceding stages. In this stage it is possible in turn to use catalysts, tetraalkyl titanates for example, which are also useful in the first stage. The reaction can then be brought to an end by addition of water, preferably corresponding to the amount of catalyst added.

It is then possible if desired to perform purification operations in order to separate off linear polyesters from the macrocyclic oligomers, by filtration or adsorption, by means of column chromatography, for example. Finally, it is also possible to perform a precipitation, in—for example—aliphatic non-solvents such as heptane. In one alternative the filler can also be introduced only after the macrocyclic oligomers have been purified and dissolved in a solvent.

These macrocyclic oligoesters can then be processed further to form linear polyesters, under isothermal conditions, for example. Examples of polyesters are polyethylene terephthalate and polybutylene terephthalate. Where this takes place in the presence of a corresponding high-boiling solvent, it is possible here as well to add nanoscale filler, again advantageously in the form of a dispersion in the solvent.

If desired, the addition of filler can of course also take place in two or more stages of the process described.

The addition of nanoscale fillers has the effect in the end product of greater stiffness and better thermal behaviour.

The term “nanoscale” for the purposes of the present invention refers to particulate material whose particles have an average diameter of 1 μm or less. These are average particle sizes as determined by XRD or laser diffraction methods. The average particle diameter is preferably less than 500 nm, with particular preference less than 250 nm, very particularly less than 200 nm. More preferably still the average particle diameter is less than 130 nm, with particular preference less than 100 nm, with very particular preference less than 80 nm, more preferably still less than 50 nm, and even <30 nm, and especially <20 nm.

Fillers which can be used in the present invention are metal salts. Preferred metal salts are those whose solubility in water and/or organic solvents is low. “Low solubility” means preferably that less than 1 g/l, more preferably less than 0.1 g/l, undergoes dissolution at room temperature (20° C.). Very particular preference is given to salts which exhibit low solubility in water and organic solvents.

Preferred cations are selected from main group 1 of the Periodic Table of the Elements, particular preference being given to Cu, Ag and Au; from main groups 2 and 3 of the Periodic Table of the Elements, preferably Mg, Ca, Sr, Ba, Zn, Al and In; from main group 4 of the Periodic Table of the Elements, preferably Ti, Zr, Si, Ge, Sn and Pb; and from main group 6 of the Periodic Table of the Elements, preferably Cr and W. Further preferred cations are metals from the transition groups of the Periodic Table of the Elements, including the lanthanoid metals. The invention also relates to mixtures of such cations.

Preferred anions are PO₄³⁻, SO₄²⁻, CO₃²⁻, F⁻, O²⁻ and OH⁻. These also include salts having two or more of these anions, such as oxyfluorides, and also hydrates of salts and mixtures thereof.

Fillers used with very particular preference are BaSO₄, SrSO₄, MgCO₃, CaCO₃, BaCO₃, SrCO₃, Zn₃(PO₄)₂, Ca₃(PO₄)₂, Sr₃(PO₄)₂, Ba₃(PO₄)₂, Mg₂(PO₄)₂, SiO₂, Al₂O₃, MgF₂, CaF₂, BaF₂, SrF₂, TiO₂, ZrO₂, fluorides and oxyfluorides of lanthanoid metals and also alkali metal and alkaline earth metal fluorometallates and mixtures thereof, such as BaSO₄/CaCO₃ mixture. An example of mixed salt is Ba/TiO₃

Where the stated metal salts are not obtained in the form of nanoparticles during the actual precipitation, they can be converted into nanoparticles by known processes. By way of example, relatively large particles can be comminuted in mills having loose grinding media. In accordance with German laid-open specification DE-A 19832304, grinding in such a mill can be carried out with the addition of dry ice or similar gases such as HFC-134a. This can be done preferably in the presence of a dispersant. Dispersants which can be used are elucidated later on below.

A further possibility of producing nanoparticles exists in the case of those substances which are prepared by precipitation. Even during the actual precipitation it is possible to add crystallization inhibitors to these substances, and/or to add a dispersant to them during or after precipitation. A selection of suitable crystallization inhibitors is described later on below. Where the salt to be used possesses no propensity towards unwanted enlargement of the crystals, a crystallization inhibitor is unnecessary. The use of a dispersant is preferred and advantageous even when a crystallization inhibitor is added. Highly suitable dispersants are elucidated below, with reference to the use of barium sulphate, in more detail.

A particularly preferred filler is nanoscale barium sulphate. The invention is elucidated further with reference to this particularly preferred filler.

It is known that barium sulphate is in fact prepared in the form of very small primary particles; however, these primary particles take up formation into particles in the form of agglomerates, which are far larger. The advantages of the small primary particles therefore do not come to bear in the case of barium sulphate. To convert the agglomerates into smaller particles can be accomplished only with a great deal of effort.

Here, the international patent application filed as PCT/EP04/013612, unpublished at the priority date of the present specification, offers a solution. The barium sulphate disclosed therein contains an optional crystallization inhibitor and also a dispersant, is in the form of nanoscale deagglomerated or deagglomerable particles, and is especially suitable for application as a filler in the present invention.

The deagglomerated barium sulphate described in the aforementioned international application PCT/EP04/013612 possesses preferably an average (primary) particle size <0.1 μm and comprises an optional crystallization inhibitor and a dispersant. Preference is given to deagglomerated barium sulphate having an average (primary) particle size of <0.08 μm (i.e. 80 nm), with very particular preference <0.05 μm (i.e. 50 nm), more preferably still <0.03 μm (i.e. 30 nm). Outstanding particles are those with sizes <20 μm, especially those with an average primary particle size of <10 nm. The lower limit on the primary particle size is for example 5 nm, but may also be even lower. The particle sizes in question are average particle sizes as determined by XRD or laser diffraction methods. The barium sulphate preferably has a BET surface area of at least 30 m²/g, in particular at least 40 m²/g, with particular preference at least 45 m²/g, and with very particular preference at least 50 m²/g. Often the upper limit is, for example, 60 m²/g, but may also be higher. Particularly advantageous barium sulphate is that having an average primary particle size <50 nm, preferably <20 nm, which is in substantially agglomerate-free form, and in which the average secondary particle size is therefore not more than 30% greater than the average primary particle size.

It is known that, in the course of its conventional preparation, barium sulphate forms agglomerates (“secondary particles”) made up of primary particles. The term “deagglomerated” in this context does not mean that the secondary particles have been broken down completely into primary particles which exist in isolation. It means that the secondary barium sulphate particles are not in the same agglomerated state in which they are typically produced in precipitations, but instead are in the form of smaller agglomerates. The deagglomerated barium sulphate of the invention preferably contains agglomerates (secondary particles) which have an average particle diameter of less than 2 μm, preferably less than 1 μm. With particular preference the average particle diameter of the secondary particles is smaller than 250 nm, with very particular preference smaller than 200 nm. More preferably still it is smaller than 130 nm, with particular preference smaller than 100 nm, with very particular preference smaller than 80 nm; more preferably still 50 nm, and even it is less than 30 nm. In part or even in substantial entirety the barium sulphate is in the form of unagglomerated primary particles. The average particle sizes in question are those determined by XRD or laser diffraction methods.

A preferred barium sulphate is obtainable by precipitating barium sulphate in the presence of a crystallization inhibitor, a dispersant being present during the precipitation and/or the barium sulphate being deagglomerated after the precipitation in the presence of a dispersant. The preparation is elucidated in more detail later on below.

The amount of crystallization inhibitor and dispersant in the deagglomerated barium sulphate is flexible. Per part by weight of barium sulphate it is possible for there to be up to 2 parts by weight, preferably up to 1 part by weight, each of crystallization inhibitor and dispersant.

Crystallization inhibitor and dispersant are present preferably in an amount of 1% to 50% by weight each in the deagglomerated barium sulphate. The amount of the barium sulphate present is preferably from 20% to 80% by weight.

Preferred crystallization inhibitors have at least one anionic group. The anionic group of the crystallization inhibitor is preferably at least one sulphate, at least one sulphonate, at least two phosphate, at least two phosphonate or at least two carboxylate group(s).

Crystallization inhibitors present may be, for example, substances that are known to be used for this purpose, examples being relatively short-chain or else longer-chain polyacrylates, typically in the form of the sodium salt; polyethers such as polyglycol ethers; ether sulphonates such as lauryl ether sulphonate in the form of the sodium salt; esters of phthalic acid and of its derivatives; esters of polyglycerol; amines such as triethanolamine; and esters of fatty acids, such as stearic esters, as specified in WO 01/92157.

As crystallization inhibitor it is also possible to use a compound of the formula (I) or a salt thereof having a carbon chain R and n substituents [A(O)OH]

R[-A(O)OH]ₙ (I)

in which

R is an organic radical which has hydrophobic and/or hydrophilic moieties, R being a low molecule mass, oligomeric or polymeric, optionally branched and/or cyclic carbon chain which optionally contains oxygen, nitrogen, phosphorus or sulphur heteroatoms, and/or being substituted by radicals which are attached via oxygen, nitrogen, phosphorus or sulphur to the radical R, and

A being C, P(OH), OP(OH), S(O) or OS(O),

and n being 1 to 10 000.

In the case of monomeric or oligomeric compounds, n is preferably 1 to 5.

Useful crystallization inhibitors of this kind include hydroxy-substituted carboxylic acid compounds. Highly useful examples include hydroxy-substituted monocarboxylic and dicarboxylic acids. Such carboxylic acids preferably have 1 to 20 carbon atoms in the chain (reckoned without the carbon atoms of the COO groups), such as citric acid, malic acid (2-hydroxybutane-1,4-dioic acid), dihydroxysuccinic acid and 2-hydroxyoleic acid, for example. Very particular preference is given to citric acid and polyacrylate as crystallization inhibitor.

Also extremely useful are phosphonic acid compounds having an alkyl (or alkylene) radical with a chain length of 1 to 10 carbon atoms. Useful compounds in this context are those having one, two or more phosphonic acid radicals. They may additionally be substituted by hydroxyl groups. Highly useful examples include 1-hydroxyethylenediphosphonic acid, 1,1-diphosphonopropane-2,3-dicarboxylic acid and 2-phosphonobutane-1,2,4-tricarboxylic acid. These examples show that compounds having not only phosphonic acid radicals but also carboxylic acid radicals are likewise useful.

Also very useful are compounds which contain 1 to 5 or an even greater number of nitrogen atoms and also 1 or more, for example up to 5, carboxylic acid or phosphonic acid radicals and which are optionally substituted additionally by hydroxyl groups. These include, for example, compounds having an ethylenediamine or diethylenetriamine framework and carboxylic acid or phosphonic acid substituents. Examples of highly useful compounds include diethylentriaminepentakis(methanephosphonic acid), iminodisuccinic acid, diethylenetriaminepentaacetic acid and N-(2-hydroxyethyl)ethylenediamine-N,N,N-triacetic acid.

Also very useful are polyamino acids, an example being polyaspartic acid.

Also extremely useful are sulphur-substituted carboxylic acids having 1 to 20 carbon atoms (reckoned without the carbon atoms of the COO group) and 1 or more carboxylic acid radicals, an example being sulphosuccinic acid bis-2-ethylhexyl ester (dioctyl sulphosuccinate).

The crystallization inhibitor is preferably an optionally hydroxy-substituted carboxylic acid having at least two carboxylate groups; an alkyl sulphate; an alkylbenzenesulphonate; a polyacrylic acid; a polyaspartic acid; an optionally hydroxy-substituted diphosphonic acid; ethylenediamine or diethylenetriamine derivatives containing at least one carboxylic acid or phosphonic acid and optionally substituted by hydroxyl groups; or salts thereof.

It is of course also possible to use mixtures of the additives, including mixtures, for example, with further additives such as phosphorous acid.

The preparation of the above-described barium sulphate intermediate with the crystallization inhibitors, particularly those of the formula (I), is advantageously carried out by precipitating the barium sulphate in the presence of the envisaged crystallization inhibitor. It can be advantageous if at least part of the inhibitor is deprotonated; for example, by using the inhibitor at least in part, or entirely, as an alkali metal salt, a sodium salt for example, or as an ammonium salt. Naturally it is also possible to use the acid and to add a corresponding amount of the base, or in the form of an alkali metal hydroxide solution.

The deagglomerated barium sulphate to be used as filler comprises not only the crystallization inhibitor but also an agent which has a dispersing action. This dispersant prevents the formation of undesirably large agglomerates when added during the actual precipitation. Its purpose is to stabilize the dispersion in the solvent. The dispersants typically act by electrostatic forces (the outwardly directed charges on the surface act by repulsion to prevent the formation of agglomerates) or by steric effects. As will be described later on below, the dispersant can also be added in a subsequent deagglomeration stage; it prevents reagglomeration and ensures that agglomerates are readily redispersed.

The dispersant preferably has one or more anionic groups which are able to interact with the surface of the barium sulphate. Such anionic groups will act as anchor groups for the surface of the barium sulphate particles. Preferred groups are the carboxylate group, the phosphate group, the phosphonate group, the bisphosphonate group, the sulphate group and the sulphonate group.

Dispersants which can be used include some of the above-mentioned agents which as well as a crystallization inhibitor effect also have a dispersing effect. When agents of this kind are used, it is possible for crystallization inhibitor and dispersant to be identical. Suitable agents can be determined by means of routine tests. The consequence of agents of this kind with a crystallization inhibitor and dispersing effect is that the precipitated barium sulphate is obtained as particularly small primary particles and forms readily redispersible agglomerates. Where an agent of this kind having both crystallization inhibitor and dispersing effect is used, it may be added during the precipitation and, if desired, deagglomeration may additionally be carried out in its presence.

It is usual to use different compounds having crystallization inhibitor action and dispersing action.

Very advantageous deagglomerated barium sulphate is that comprising dispersants of a kind which endow the barium sulphate particles with a surface which prevents reagglomeration and/or inhibits agglomeration electrostatically, sterically, or both electrostatically and sterically. Where such a dispersant is present during the actual precipitation, it inhibits the agglomeration of the precipitated barium sulphate, so that deagglomerated barium sulphate is obtained even at the precipitation stage. Where such a dispersant is incorporated after the precipitation, as part of a wet-grinding operation, for example, it prevents the reagglomeration of the deagglomerated barium sulphate after the deagglomeration. Barium sulphate comprising a dispersant of this kind is especially preferred on account of the fact that it remains in the deagglomerated state.

A particularly advantageous deagglomerated barium sulphate is characterized in that the dispersant has carboxylate, phosphate, phosphonate, bisphosphonate, sulphate or sulphonate groups which are able to interact with the barium sulphate surface (anchor group for the surface of the barium sulphate particles), and in that it has one or more organic radicals R¹ which have hydrophobic and/or hydrophilic moieties.

Preferably R¹ is a low molecular mass, oligomeric or polymeric, optionally branched and/or cyclic carbon chain which optionally contains oxygen, nitrogen, phosphorus or sulphur heteroatoms and/or is substituted by radicals which are attached via oxygen, nitrogen, phosphorus or sulphur to the radical R¹ and the carbon chain is optionally substituted by hydrophilic or hydrophobic radicals. One example of substituent radicals of this kind are polyether or polyester based side chains. Preferred polyether based side chains have 3 to 50, preferably 3 to 40, in particular 3 to 30 alkyleneoxy groups. The alkyleneoxy groups are preferably selected from the group consisting of methyleneoxy, ethyleneoxy, propyleneoxy and butyleneoxy groups. The length of the polyether based side chains is generally from 3 to 100 nm, preferably from 10 to 80 nm.

The barium sulphate may comprise a dispersant which has groups for coupling to or into polymers. Such groups will act as anchor groups for the polymer matrix. These may be groups which bring about this coupling chemically, examples being OH, NH, NH₂, SH, O—O peroxo, C—C double bond or 4-oxybenzonphenone propylphosphonate groups. The groups in question may also be groups which bring about physical coupling.

An example of a dispersant which renders the surface of the barium sulphate hydrophobic is represented by phosphoric acid derivatives in which one oxygen atom of the P(O) group is substituted by a C₃-C₁₀ alkyl or alkenyl radical and a further oxygen atom of the P(O) group is substituted by a polyether side chain. A further acidic oxygen atom of the P(O) group is able to interact with the barium sulphate surface.

The dispersant may be, for example, a phosphoric diester having a polyether or a polyester based side chain and a C6-C10 alkenyl group as moieties. Phosphoric esters with polyether/polyester side chains such as Disperbyk®111, phosphoric ester salts with polyether/alkyl side chains such as Disperbyk®102 and 106, substances having a deflocculating effect, based for example on high molecular mass copolymers with groups possessing pigment affinity, such as Disperbyk®190, or polar acidic esters of long-chain alcohols, such as Disperplast®1140, are further highly useful types of dispersants.

A barium sulphate having especially good properties in the present invention comprises as dispersant a polymer which has anionic groups which are able to interact with the surface of the barium sulphate (anchor groups for the surface of the barium sulphate particles), examples being the groups specified above, and contains groups for coupling to or into polymers, such as OH, NH, or NH₂ groups (anchor groups for the polymer matrix). Preferably there are polyether or polyester based side chains present which contain OH, NH, or NH₂ groups. Barium sulphate of this kind exhibits no propensity to reagglomerate. In the course of the application there may even be further deagglomeration.

As a result of the substitution with polar groups, especially hydroxyl groups and amino groups, the barium sulphate particles are externally hydrophilicized.

Barium sulphate of this kind, having a crystal growth inhibitor and one of the particularly preferred dispersants that prevents reagglomeration sterically, especially a dispersant substituted by anchor groups for the polymer matrix as described above, has the great advantage that it comprises very fine primary particles and comprises secondary particles whose degree of agglomeration is low at most, these particles, since they are readily redispersible, having very good application properties—for example, they can be incorporated readily into polymers and do not tend towards reagglomeration, and indeed even undergo further deagglomeration in the course of the application. Moreover, the hydroxyl groups, as already indicated above, may even participate in the reaction of the diols with dicarboxylic acids or their esters.

It is admittedly entirely possible to incorporate the barium sulphate (or one of the other abovementioned fillers) in dry form into the selected reaction stage during the preparation of the hydroxyalkyl-terminated esters, the esters of medium molecular weight or the macrocyclic polymers. With advantage, however, the barium sulphate is employed as a dispersion in the corresponding diol and/or in the particular solvent used.

In the dispersion in the diol or solvent, the deagglomerated barium sulphate is present typically in an amount of 0.1% to 70% by weight, preferably in an amount of 0.1% to 60% by weight, for example 0.1% to 25% by weight or 1% to 20% by weight.

The dispersion may further comprise modifiers or additives; by way of example, it would be possible here to introduce the catalyst as well.

International patent application PCT/EP04/013612 provides a number of methods of providing deagglomerated barium sulphate.

The first method envisages precipitating barium sulphate, optionally in the presence of a crystallization inhibitor, and then carrying out a deagglomeration. This deagglomeration is carried out in the presence of a dispersant.

The second method envisages precipitating barium sulphate in the presence of an optional crystallization inhibitor and a dispersant. In the course of the subsequent deagglomeration in the solvent envisaged it is likewise possible for a dispersant to be present.

According to the invention, the deagglomerated barium sulphate can be obtained by wet-grinding a barium sulphate precipitated using an optional crystallization inhibitor, the wet grinding taking place in the presence of the dispersant, with the proviso that crystallization inhibitor and dispersant may also be the same. In another embodiment, the deagglomerated barium sulphate can be obtained by precipitating barium sulphate in the optional presence of a crystallization inhibitor and in the presence of a dispersant which prevents reagglomeration and/or inhibits agglomeration electrostatically, sterically, or both electrostatically and sterically.

The first method is now elucidated in more detail.

Barium sulphate is precipitated by typical methods, such as by reacting barium chloride or barium hydroxide with alkali metal sulphate or sulphuric acid. In the course of this precipitation, methods are employed in which primary particles are formed with the fineness indicated above. In the course of the precipitation, additives may be employed which inhibit crystallization, examples being those as specified in WO 01/92157, or the aforementioned compounds of the formula (I) which have a crystallization inhibitor effect. The precipitated barium sulphate is dewatered. This is followed by wet deagglomeration. The liquid chosen is appropriately the diol or the solvent, o-dichlorobenzene for example, in which the barium sulphate is to be introduced in dispersed form into the respective stage of the ester preparation.

The deagglomeration, which is carried out for example in a bead mill, a vibratory mill, an agitator-mechanism mill, a planetary ball mill or a dissolver with glass spheres, then takes place in the presence of a dispersant. The dispersants have been specified above; it is possible, for example, to use an agent of the formula (I) that has dispersing properties. In this case the crystallization inhibitor and the dispersant may be the same. The crystallization inhibitor effect is utilized in the course of the precipitation, the dispersing effect in the course of the deagglomeration. For the deagglomeration it is preferred to use those dispersants which contain at least one polyether or polyester based side chain and which therefore prevent reagglomeration sterically. Especially, those dispersants are substituted by hydroxyl groups.

The grinding and deagglomeration are carried out until the desired degree of deagglomeration has been reached. The deagglomeration is preferably carried out until the deagglomerated barium sulphate of the invention has secondary particles whose average particle size is smaller than 1 μm, more preferably smaller than 250 nm, with very particular preference smaller than 200 nm. With even greater preference deagglomeration is carried out until the average particle size is smaller than 130 nm, with particular preference smaller than 100 nm, with very particular preference smaller than 80 nm, more preferably still <50 nm. The barium sulphate in this case may in part or even in substantial entirety, as stated above, be present in the form of unagglomerated primary particles. The average particle sizes are determined by XRD or laser diffraction methods. The dispersion of deagglomerated barium sulphate, comprising a crystallization inhibitor and a dispersant, that is formed in the course of the wet deagglomeration, in the diol or solvent, is then added to the ester reaction.

The second preparation method envisages carrying out the precipitation, for example by reacting barium chloride or barium hydroxide with alkali metal sulphate or sulphuric acid, optionally in the presence of a crystallization inhibitor, and in the presence of a dispersant. This procedure leads to the formation of readily redispersible deagglomerated barium sulphate during the actual precipitation. Dispersants of this kind, which endow the barium sulphate particles with a surface which prevents reagglomeration and inhibits agglomeration during the precipitation electrostatically, sterically, or both electrostatically and sterically, have been elucidated earlier on above. This embodiment produces a barium sulphate deagglomerated within the meaning of the invention as early as during the precipitation stage.

The thus-precipitated barium sulphate, comprising an optional crystallization inhibitor and dispersant, is in turn dewatered, by means of spray drying, for example. The agglomerates formed in this procedure are then dispersed in the diol or solvent and form deagglomerated particles again. Thereafter the dispersion is added to the ester reaction.

The present invention also relates to a precursor of macrocyclic oligoesters, namely hydroxyalkyl-terminated polyester oligomers; an intermediate of macrocyclic oligoesters, namely polyesters having a molecular weight of 20 000 to 70 000 daltons; and an end product of macrocyclic oligoesters, obtainable by heating of the macrocyclic oligoesters, namely polyesters; all of them being characterized by the presence therein of nanoscale inorganic fillers, preferably of nanoscale barium sulphate.

The macrocyclic polyester oligomer or the finished product containing nanoscale filler, in particular containing barium sulphate, is then used for the known purposes of application. For example, the ester oligomer can be polymerized to polybutylene terephthalate, which is used in compounding applications, in casting or injection moulding processes, in nanocomposites, in rotational moulding applications and in composite materials, as a construction material, in watercraft construction, in wind turbines for the rotors, for fuel tanks, in aircraft construction and in vehicle construction.

The nanoparticle-containing materials are distinguished by relatively high thermal stability, strength and stiffness.

The examples which follow are intended to illustrate the invention without restricting it in its scope.

### EXAMPLES

Preparation takes place as described in PCT/EP04/013612.

### Example 1

### Preparation of Finely Divided Barium Sulphate as an Intermediate by Precipitation in the Presence of Crystallization Inhibitors

### General Experimental Instructions:

a) Routine experiment:

A high 600 ml glass beaker was charged with 200 ml of additive solution (containing 2.3 g of citric acid and 7.5 g of Melpers®0030 and 50 ml of sodium sulphate solution with a concentration of 0.4 mol/l. Stirring was carried out centrally in the solution by means of an Ultraturrax stirrer as dispersing aid at 5000 rpm. In the vortex region of the Ultraturrax the barium chloride solution (concentration: 0.4 mol/l) was supplied by means of a Dosimat automatic metering device.
b) The example described as 1a) is repeated but using 200 ml of additive solution containing 2.3 g of citric acid and 50 ml of sodium sulphate solution, but no Melpers®0030.
c) Unit (V):

An apparatus was used as described in WO 01/92157, in which forces of thrust, shear and friction act on the reaction mixture. The crystallization inhibitor (see Table below) was added in the initial charge of the sulphate solution.

| | | | | | | d 50 without |
|---|---|---|---|---|---|---|
| trade name of the | chemical identity | amount of | | BET | XRD | pretreatment |
| crystallization | according to | additive | pH of | value | value | of suspension |
| inhibitor | manufacturer | [%] | suspension | [m²/g] | d [nm]* | [μm]** |
| Citronensäure, | citric acid | 7.5 | 12.43 | 75.2 | 22 | 0.287 |
| Merck | | | | | | |
| Citronensäure, | citric acid | 15 | 7.13 | 73 | 18 | 0.142 |
| Merck | | | | | | |
| HEDP, Fluka | 1-hydroxy- | 21.6 | 5.9 | 63.4 | 16 | 0.228 |
| | ethylenediphosphonic | | | | | |
| | acid tetrasodium salt | | | | | |
| Baypur CX | iminodisuccinic | 15 | 9.6 | 55.9 | 22 | 1.281 |
| 100/34% | acid sodium salt in | | | | | |
| | aqueous solution | | | | | |
| Dispex N40, | neutral sodium salt | 3 | 12.85 | 53.9 | 28 | 0.167 |
| Ciba | of a polycarboxylic | | | | | |
| | acid (polyacrylate), | | | | | |
| | molar weight | | | | | |
| | approx. 3500 Da, | | | | | |
| | lowest molar weight | | | | | |
| | of the Dispex series | | | | | |
| Citritex 85, | Na salt of | 15 | 6.6 | 53.6 | 31 | 0.273 |
| Jungbunzlauer | hydroxycarboxylic | | | | | |
| Ladenburg | acids | | | | | |
| GmbH | | | | | | |
| HEDP | 1-hydroxy- | 10.8 | 5.6 | 53.4 | 23 | 0.243 |
| | ethylenediphosphonic | | | | | |
| | acid tetrasodium salt | | | | | |
| DTPA-P, Fluka | diethylenetriamine | 15 | 6.97 | 52.6 | 17 | 0.169 |
| | pentakis (methane- | | | | | |
| | phosphonic acid) | | | | | |
| | solution | | | | | |
| DTPA | diethylenetriamine | 15 | 11.3 | 47.8 | 29 | 0.23 |
| | pentaacetic acid | | | | | |
| DEVItec PAA | polyaspartic acid, | 15 | 5.73 | 47.7 | 18 | 0.296 |
| | Na salt, in aqueous | | | | | |
| | solution | | | | | |
| Dispex N40 | neutral sodium salt | 15 | 10.67 | 46.6 | 19 | 0.167 |
| | of a polycarboxylic | | | | | |
| | acid (polyacrylate), | | | | | |
| | molar weight approx. | | | | | |
| | 3500 Da, lowest molar | | | | | |
| | weight of the Dispex | | | | | |
| | series | | | | | |
| HEDTA | N-(2-(hydroxy- | 3.75 | 8.3 | 46.5 | 38 | 0.317 |
| | ethyl)ethylene- | | | | | |
| | diamine-N,N,N,- | | | | | |
| | triacetic acid | | | | | |
| 4334/HV, | polycarboxylate, | 15 | 9.9 | 33 | 21 | 0.147 |
| SKW | aqueous | | | | | |
| Citronensäure | citric acid | 1.5 | 6.1 | 32.1 | 33 | 1.588 |
| Dispex N40 | neutral sodium salt | 15 | 10.08 | 32 | 21 | 0.2 |
| | of a polycarboxylic | | | | | |
| | acid (polyacrylate), | | | | | |
| | molar weight approx. | | | | | |
| | 3500 Da, lowest molar | | | | | |
| | weight of the Dispex | | | | | |
| | series | | | | | |
| DTPA-P, Fluka | diethylenetriamine | 5 | 11.38 | 31.5 | 29 | 0.197 |
| | pentakis (methane- | | | | | |
| | phosphonic acid) | | | | | |
| | solution | | | | | |
| HEDP | 1-hydroxyethylene- | 15 | 2.99 | 30.3 | 34 | 0.364 |
| | diphosphonic acid | | | | | |
| | tetrasodium salt | | | | | |
| 4334/HV | polycarboxylate, | 15 | 6.84 | 30.2 | 23 | 0.152 |
| | aqueous | | | | | |
| DTPA-P | diethylenetriamine | 15 | 10.47 | 25.5 | 17 | 0.157 |
| | pentakis (methane- | | | | | |
| | phosphonic acid) | | | | | |
| | solution | | | | | |
| Äpfelsäure, | 2-hydroxybutane- | 15 | 10.47 | 24.2 | 28 | 1.031 |
| Merck | 1,4-dioic acid | | | | | |
| Polymethacrylsäure | polymethacrylic | 5 | 10.69 | 18.9 | 40 | 0.268 |
| 91 | acid | | | | | |
| Sokalan PA20 | Polyacrylate | 15 | 6.31 | 15.7 | 22 | 0.251 |
| Dispers 715W | Na polyacrylate, | 15 | 5.99 | 15.1 | 19 | 0.18 |
| | aqueous | | | | | |
| Hydropalat N | Na polyacrylate | 15 | 6.03 | 12.5 | 23 | 0.168 |
| VP 4334/8L | polycarboxylate, | 15 | 6.38 | 12.5 | 24 | 0.148 |
| | aqueous | | | | | |
| Dispers 715W | Na polyacrylate, | 15 | 10.82 | 12.4 | 19 | 0.161 |
| | aqueous | | | | | |

*The XRD value corresponds to the average primary particle size diameter measured by XRD
**d 50 without pretreatment of suspension corresponds to the average particle size diameter of barium sulphate particles, including both primary and secondary particles.

The above table shows further suitable crystallization inhibitors which in some cases can also be used as dispersants.

### Example 2

### Preparation of Deagglomerated Barium Sulphate

2.1. Preparation of Deagglomerated Barium Sulphate Using Melpers®0030

A barium sulphate prepared in Example 1 and containing citric acid as crystallization inhibitor is dried and subjected to wet grinding in a bead mill with addition of a dispersant in the presence of o-dichlorobenzene. The dispersant used was a polyether polycarboxylate substituted terminally on the polyether groups by hydroxyl groups (Melpers type from SKW, molar weight approximately 20 000, side chain 5800).

2.2. Preparation of a Dispersion Using Disperbyk® 102

The example 2.1 is repeated but the dispersant that is used is Disperbyk® 102, a phosphoric ester salt having polyether/alkyl side chains.

### Example 3

### Preparation of Barium Sulphate by Precipitation in the Presence of Crystallization Inhibitors and Polymeric Dispersants During Precipitation

Starting materials used were barium chloride and sodium sulphate.

3.1. Beaker Experiments:

A 200 ml graduated flask was charged with 7.77 g of the Melpers-type, terminally hydroxy-substituted polyether polycarboxylate (Melpers®0030) from SKW and made up to 200 ml with water. This quantity corresponded to 50% of Melpers (w=30% aqueous solution) based on the maximum amount of BaSO₄ formed (=4.67 g).

A 600 ml high glass beaker was charged with 50 ml of a 0.4 M BaCl₂ solution, to which the 200 ml of the Melpers solution were added. To aid dispersion an Ultraturrax was immersed centrally into the glass beaker and operated at 5000 rpm. Within the vortex region created by the Ultraturrax 50 ml of a 0.4 M Na₂SO₄ solution to which citric acid had been added (50% of citric acid, based on the maximum amount of BaSO₄ formed: 2.33 g per 50 ml/Na₂SO₄) were added via a flexible tube, using a Dosimat. Both the BaCl₂/Melpers solution and the Na₂SO₄/citric acid solution were rendered alkaline using NaOH prior to precipitation; the pH was approximately 11-12.

The barium sulphate obtained in deagglomerated form after the water has been separated off possessed a primary particle size of approximately 10 to 20 nm; the secondary particle size was in the same range, and so the barium sulphate was regarded as largely free of agglomerate.

It is then dispersed with o-dichlorobenzene as described above.

3.2. Preparation of Deagglomerated Barium Sulphate on the Pilot Plant Scale

A 30 l vessel was charged with 5 l of a 0.4 M BaCl₂ solution. 780 g of the Melpers product were added with stirring (50%, based on maximum amount of BaSO₄ formed: 467 g). To this solution there were added 20 l of demineralized water. Operated within the vessel was an Ultraturrax, in whose vortex region 5 l of a 0.4 M Na₂SO₄ solution were added via a stainless steel pipe, using a peristaltic pump. The Na₂SO₄ solution had been admixed with citric acid beforehand (233 g/5 l Na₂SO₄=50% citric acid, based on maximum amount of BaSO₄ formed). As in the case of the beaker experiments, both solutions had been rendered alkaline by means of NaOH prior to precipitation in these experiments as well. The properties in respect of primary particle size and serviceability corresponded to those of the barium sulphate from Example 3.1. The sulphate was likewise largely free from agglomerates.

3.3. Preparation of Deagglomerated Barium Sulphate with Higher Reactant Concentrations

Example 3.2 was repeated. On this occasion 1-molar solutions were used. The barium sulphate obtained corresponded to that of Example 3.2.

### Example 4

### Preparation of Barium Sulphate with Grinding and Formation of a Dispersion in o-dichlorobenzene or 1,4-butanediol

4.1. Preparation of Chemically Dispersed Barium Sulphate by Precipitation in the Presence of Crystallization Inhibitors and Subsequent Grinding in the Presence of Polymeric Dispersants

Starting materials used is barium chloride and sodium sulphate. Barium chloride solution (0.35 mol/l) and sodium sulphate solution (0.35 mol/l) are reacted in the presence of citric acid as crystallization inhibitor, with precipitation of barium sulphate. The precipitated barium sulphate is dried and added to o-dichlorobenzene. A polyether polycarboxylate substituted terminally on the polyether side chains by hydroxyl groups (Melpers®0030) is added and a dispersion of the barium sulphate particles in o-dichlorobenzene is generated further to a deagglomeration step in a bead mill The barium sulphate contained about 7.5% by weight of citric acid and about 25% by weight of the polyether polycarboxylate based on the total weight of barium sulphate, citric acid and dispersant.

4.2. Preparation Using Other Starting Compounds and a Different Crystallization Inhibitor

Example 4.1. is repeated. Barium chloride is replaced by barium hydroxide solution (0.35 mol/l) and sodium sulphate by sulphuric acid (0.35 mol/l). Instead of citric acid 3% by weight of Dispex® N40 are used (a sodium polyacrylate). Melpers®0030 was used in an amount of 8.5% by weight. Then the dispersion in o-dichlorobenzene is produced as described in 4.1.

4.3. Preparation Using 1,4-butanediol as the Continuous Phase of the Dispersion

Example 4.1. is repeated, but using 1,4-butanediol as solvent. The dispersion contains 50% by weight of the barium sulphate.

4.4. Preparation Using 1,4-butanediol and Disperbyk®102 as Dispersant

Example 4.3. is repeated but using Disperbyk® 102, a phosphoric ester salt with polyether/alkyl side chains. The dispersion contained 50% by weight of the barium sulphate.

### Example 5

### Preparation of a Macrocyclic Polyester Oligomer Containing the Deagglomerated Barium Sulphate in Chemically Dispersed Form

As described in Example 1 of U.S. Pat. No. 6,855,798, dimethyl terephthalate, 1,4-butanediol, isopropyl titanate catalyst and barium sulphate from Example 4.1, in dispersion in 1,4-butanediol, are introduced into a three-necked reactor and heated for the purpose of forming the 4-hydroxybutyl-terminated PBT oligomer. On further heating, as described in Example 2 of the US patent, a PBT of medium molecular weight is prepared that comprises the dispersed barium sulphate. On further heating, with addition of o-dichlorobenzene, the desired macrocyclic oligomer is formed with dispersed barium sulphate present therein.

### Example 6

### Introduction of the Dispersed Barium Sulphate During the Preparation of the Macrocyclic Oligomer

6.1. Melpers® 0030 as Dispersant

Deagglomerated barium sulphate, prepared as described in Example 4.2. using citrate and the hydroxyl-substituted polyether carboxylate of the Melpers type, is deagglomerated in the form of a spray-dried powder in o-dichlorobenzene.

The dispersion is then added to the medium molecular weight polymer instead of the filler-free o-dichlorobenzene, in analogy to Example 3 of the US patent. The reaction mixture is then heated, and, as described in Example 3 of the US patent, the macrocyclic polyester oligomer is formed.

The macrocyclic polyester oligomer can then be processed further to form linear PBT polymer mouldings.

6.2. Disperbyk® 102 as Dispersant

The barium sulphate prepared in accordance with Example 2 with Disperbyk® 102 as dispersant is introduced as in 6.1. into the reaction mixture, in order to produce the macrocyclic polyester oligomer containing barium sulphate.

As an alternative the barium sulphate can be introduced after linear constituents have been separated from the reaction mixture, the macrocyclic esters have been dissolved, and the mixture, then containing barium sulphate, has been precipitated, by means, for example, of removal of the solvent and addition of heptane.

The polymerization of the macrocyclic esters can then be brought about with stannoxane at 190° C. as described in U.S. Pat. No. 6,855,798 in Example 4.

1. A macrocyclic oligoester, prepared by reacting a dicarboxylic acid or a dicarboxylic ester with a diol to form a composition which comprises a polyester oligomer and heating the composition in the presence of a solvent and a catalyst to give the macrocyclic oligoester, the macrocyclic oligoester comprising nanoscale particles (nanoparticles) of inorganic fillers.

2. The macrocyclic oligoesters according to claim 1, wherein the inorganic fillers are metal salts whose cations are selected from main group 1 of the Periodic Table of the Elements, from main groups 2 and 3 of the Periodic Table of the Elements, from main group 4 of the Periodic Table of the Elements, from main group 6 of the Periodic Table of the Elements, and from the transition groups of the Periodic Table of the Elements, including the lanthanoid metals, and mixtures thereof, and whose anions are selected from PO₄³⁻, SO₄²⁻, CO₃²⁻, F⁻, O²⁻ and OH—, including nanoparticles having two or more of these anions, such as oxyfluorides, and also hydrates of salts and mixtures thereof.

3. The macrocyclic oligoesters according to claim 1, wherein the nanoparticles of inorganic filler have an average primary particle size <500 nm.

4. The macrocyclic oligoesters according to claim 3, wherein the inorganic filler comprises a dispersant.

5. The macrocyclic oligoesters according to claim 3, wherein the filler is barium sulphate and the barium sulphate is a deagglomerated barium sulphate comprising an optional crystallization inhibitor and a dispersant.

6. The macrocyclic oligoesters according to claim 5, wherein the barium sulphate particles comprise primary and secondary barium sulphate particles, the secondary barium sulphate particles having an average particle diameter of smaller than 2000 nm.

7. The macrocyclic acrocyclic oligoesters according to claim 4, characterized in that wherein a crystallization inhibitor is comprised of and is selected from compounds having at least one anionic group, the anionic group being selected from sulfate, sulphonate, phosphate, phosphonate, carboxylate group(s), and mixtures thereof.

8. (canceled)

9. The macrocyclic oligoesters according to claim 7, wherein the crystallization inhibitor is a compound of the formula (I) or a salt thereof comprising a carbon chain R and n substituents [A(O)OH],
R[-A(O)OH]ₙ (I)
in which R is an organic radical which has hydrophobic and/or hydrophilic moieties, R being a low molecular mass, oligomeric or polymeric, optionally branched and/or cyclic carbon chain which optionally comprises oxygen, nitrogen, phosphorus or sulphur heteroatoms, and/or being substituted by radicals which are attached via oxygen, nitrogen, phosphorus or sulphur to the radical R, A being C, P(OH), OP(OH), S(O) or OS(O), and n being 1 to 10 000.

10. The macrocyclic oligoesters according to claim 5, wherein the crystallization inhibitor is an optionally hydroxy-substituted carboxylic acid having at least two carboxylate groups; an alkyl sulphate; an alkylbenzenesulphonate; a polyacrylic acid; a polyaspartic acid; an optionally hydroxy-substituted diphosphonic acid; ethylenediamine or diethylenetriamine derivatives comprising at least one carboxylic acid or phosphonic acid and optionally substituted by hydroxyl groups; or salts thereof.

11. The macrocyclic oligoesters according to claim 5, wherein the dispersant comprises anionic groups which are able to interact with the surface of the barium sulphate, preferably the anionic groups being selected from carboxylate, phosphate, phosphonate, bisphosphonate, sulphate, and sulfonate groups.

12. The macrocyclic oligoesters according to claim 11, wherein the dispersant comprises one or more organic radicals R¹ which have hydrophobic and/or hydrophilic moieties.

13. The macrocyclic oligoesters according to claim 12, wherein R¹ is a low molecular mass, oligomeric or polymeric, optionally branched and/or cyclic carbon chain which optionally comprises oxygen, nitrogen, phosphorus or sulphur heteroatoms and/or is substituted by radicals which are attached via oxygen, nitrogen, phosphorus or sulphur to the radical R¹ and the carbon chain is optionally substituted by hydrophilic or hydrophobic radicals.

14. The macrocyclic oligoesters according to claim 13, wherein the dispersant is a phosphoric diester having a polyether based side chain and a C6 C10 alkenyl group as moieties.

15. The macrocyclic oligoesters according to claim 11, wherein the dispersant comprises at least one group for coupling to or into polymers, selected from OH, NH, or NH₂ groups.

16. (canceled)

17. The macrocyclic oligoesters according to claim 15, wherein the dispersant comprises at least one polyether or polyester based side chain.

18. The macrocyclic oligoesters according to claim 17, wherein the polyether or polyester based side chains contain comprise groups for coupling to or into polymers.

19. The macrocyclic oligoesters according to claim 18, wherein the dispersant is a polyether polycarboxylate which is substituted terminally on the polyether based chains by hydroxyl groups.

20. The macrocyclic oligoesters according to claim 5, wherein the crystallization inhibitor and the dispersant are each present in the deagglomerated barium sulphate in an amount of up to 2 parts by weight per part by weight of barium sulphate.

21. The macrocyclic oligoesters according to claim 5, wherein the deagglomerated barium sulphate is obtained
a) by wet-grinding a barium sulphate precipitated using a crystallization inhibitor, the wet grinding taking place in the presence of the dispersant, with the proviso that crystallization inhibitor and dispersant may also be the same, or
b) by precipitating barium sulphate in the presence of a crystallization inhibitor and of a dispersant which prevents reagglomeration and/or inhibits agglomeration electrostatically, sterically, or both electrostatically and sterically.

22. The macrocyclic oligoesters according to claim 1 comprising a barium sulphate content in the range from 1% to 70% by weight.

23. A precursor of the macrocyclic oligoesters of claim 1 chosen from hydroxyalkyl-terminated polyester oligomers, comprising therein nanoscale inorganic fillers.

24. An intermediate of the macrocyclic oligoesters of claim 1, chosen from polyesters having a molecular weight of 20 000 to 70 000 daltons, comprising therein nanoscale inorganic fillers.

25. (canceled)

26. An end product of the macrocyclic oligoesters of claim 1, chosen from polyesters comprising therein nanoscale inorganic fillers, and obtained by heating the macrocyclic oligoesters.

27. A method of use of barium sulphate having an average primary particle size <500 nm and an average secondary particle size <2000 nm and comprising a crystallization inhibitor and a dispersant, as a filler for hydroxyalkyl-terminated polyester oligomers, macrocyclic oligoesters and polyesters.
